(19) United States
(12) Patent Application Publication
(10) Pub. No.: US 2013/0068488 A1
(43) Pub. Date: Mar. 21, 2013

(54) VEHICLE FIRE PROTECTIVE COVER

(71) Applicants: Robert James Walker, Brisbane (AU); Matthew Robert Walker, Brisbane (AU)

(72) Inventors: Robert James Walker, Brisbane (AU); Matthew Robert Walker, Brisbane (AU)

(21) Appl. No.: 13/699,209

(22) PCT Filed: May 20, 2011
(86) PCT No.: PCT/AU2011/000600

§ 371 Date: Nov. 20, 2012

(30) Foreign Application Priority Data
May 24, 2010 (AU) 2010902255

(51) Int. Cl. A62C 2/06

(52) U.S. Cl. 169/48

(57) ABSTRACT

A fire protection external vehicle cover including a plurality of panels of a fire retardant material or textile. Each panel is configured to cover an adjacent portion of the cabin of the vehicle; with one or more panels including a retention mechanism to secure the panels by gripping between closed doors and door frames of the cabin. A storage and deployment mechanism is configured to store and deploy the cover from one or more locations on the vehicle; wherein in operation, when deployed, the cover forms an enclosure over the cabin thereby protecting external surfaces of the cabin and thus its occupants and an internal lining of the vehicle from exposure to radiant heat, burning embers and flames if the vehicle is moving through or becomes trapped in a fire.

### FIELD OF THE INVENTION

This invention relates to a survival apparatus, in particular but not limited to, a fire protective cover for a vehicle used in controlling bushfires and forest fires.

### BACKGROUND OF THE INVENTION

During wildfire events, natural disasters, or other catastrophes, vehicles may be exposed to extreme heat or flame impingement which may threaten the well being of occupants of those vehicles. Vehicles, especially fire agency, land management vehicles, and other emergency personal vehicles can become trapped in a ‘fire storm’ or ‘burn over’ during fire suppression operations or the like. In this regard, it is widely accepted, that protection of the vehicle cabin during these events can significantly increase survival expectation of the occupants thereof until the danger has passed.

Prior art reflective fire curtains presently available are fitted internally and fixed to the vehicle's cabin, and when not in use, rolled up and held in place above the cabin windows. Although they provide some degree of protection from heat and flame impingement, in an emergency fire situation they provide no external protection for the glass which is exposed directly to heat and flames, resulting in breakage. It is imperative that in such a situation the glass is kept intact, so as to maintain the oxygen levels within the cabin and to prevent the entry of toxic fumes, such as smoke and other toxins that may be present in the air as a result of the fire. Presently, in an attempt to solve this problem, an external water spray system above the windows is installed, which can be inefficient due to the prevailing weather conditions or strong thermal currents caused by the fire, which often deflect the protective spray away from the windows. Moreover, to implement this solution, a large reservoir of water is obviously required, which is not easily adapted for use with general vehicles, such as people movers, mobile homes, trailers and the like. Lastly, the requirement that approximately 25% of the total water capacity of a fire fighting vehicle be retained for this use adversely impacts the primary fire suppression role and operational capacity of a fire fighting vehicle.

The lack of protection of the external surfaces exposes these surfaces of the cabin to intense heat, which is transferred through the doors, roof and other sections of the vehicle to the internal cabin linings. Moreover, these internal cabin linings are often made from plastic-based materials which can generate toxic gases detrimental to the survival of the occupants during the period of exposure.

Current fire protection curtains are held in position usually by riveting, by using press studs or using adhesive backed Velcro to secure the material to the cabin or internal vinyl trim. These methods, however, can involve a significant amount of time and effort for trained technicians to install. Furthermore, they can be inefficient and become compromised during exposure to an intense fire, due to deformation and degradation of materials.

Current fire protection curtains which are stowed, internally present a safety issue because of their tendency to obstruct a driver's vision. Their effectiveness and use can also be limited relevant jurisdictional vehicle safety standards.

### OBJECT OF THE INVENTION

It is the object of the invention to ameliorate some or all of the above disadvantages of the prior art by providing a novel and innovative fire safety vehicle cover.

### STATEMENT OF INVENTION

In one aspect the invention resides in a fire protection external vehicle cover comprising in combination:

a plurality of reflective panels of a heat dissipating and/or thermal insulating material or textile;

each panel configured to cover an adjacent portion of a cabin or body of the vehicle;

one or more panels having retention means to secure the panels by gripping between the closed doors and door frames of the cabin or the body;

storage and deployment means adapted to store and deploy the cover from one or more locations on the vehicle;

where in operation, when deployed, the cover forms an enclosure over the cabin or the body thereby protecting the external surfaces of the cabin or the body and thus any occupants from exposure to radiant heat, burning embers and flames if the vehicle becomes trapped in a fire.

Preferably, the material or textile is a reflective single or multi-layered thermal insulating and/or heat dissipating fabric or other reflective material which, when deployed, protects the glass sections such as the windows and windscreen of the vehicle by preventing them from shattering under intense heat and also inhibits heat transfer through the doors, roof and other portions of the cabin from reaching the interior trim and plastic areas inside the vehicle. More preferably, the reflective material or textile that is a single or multi-layered thermal insulating and/or heat dissipating fabric or other material is constructed of a flexible and fibre reinforced material and has heat deflective properties. The reinforced material used in the present invention is not overly limited, as those skilled in the art would appreciate that any material having the ability to provide thermal insulating and/or deflective properties can be used. However, preferred reinforced materials include, but are not limited to, Kevlar fibres, glass fibres, carbon fibres, aramid fibres, and combinations thereof.

The reduction in heat transfer into the vehicle cabin potentially reduces any toxic fumes released by the linings and plastic surfaces of the cabin trim and upholstery.

Preferably there can be a clear heatproof portion of the panel covering the windscreen to allow vision when driving the vehicle, for example, through a fire storm.

In the alternative, there may be liftable portion or removable panel for this purpose.

Preferably, the storage and deployment means comprises one or more containers mounted on the roof of the vehicle which stores the cover in a rolled up or folded up configuration. In the alternative, the storage and deployment means can be mounted on another part of the vehicle.

Preferably, deployment is rapidly effected under gravitational means when the cover is released from the storage and deployment enclosures.

Preferably the retaining means for the panels of the cover comprise straps or tags that can be secured between the door frames and the closed doors of the vehicle body.

Preferably, when deployed, panels can be further tensioned through the tightening the straps or tags, or use of tension drawstrings accessible from within the cabin.

Preferably, the panels overlap one another so that gaps do not exist to allow embers or heat from infiltrating the cover to affect the cabin.

Preferably the storage and deployment means may include mechanical aids to effect rapid deployment of the cover such as sliding, hinged, pivoting, springs and rotating lever arms or rollers to facilitate unfolding or unfurling of the panels and the positioning of the retention straps or tags between the doors and the door frames.

More preferably, where mechanical aids are used to effect deployment of an unfolding cover, torsion springs or a pneumatic system with varying strengths are used to assist in rapidly unfolding the panels in a successive, predetermined order to cover the vehicle. When stored, the panels are folded against the bias of the spring or pneumatic rams and retained in place in a storage and deployment container strategically located on the vehicle.

Preferably, where mechanical aids are used to effect deployment of the cover, the automatic deployment will be triggered by a mechanism accessible from within the vehicle, such as a manual switch, switching means or an automatic trigger based on a thermostat or fusible link responsive to ambient temperature operating a retaining pin or solenoid device. After deployment, the cover can be more securely retained through the use straps or tags that can be secured between the door frames and the closed doors of the vehicle.

### BRIEF DESCRIPTION OF THE DRAWINGS

In order for the invention to be better understood reference will now be made to the accompanying drawings, wherein;

FIG. 1 shows the flat plane development of two preferred embodiments of the subject invention, according to Example A, 10 and Example B, 12.

FIGS. 2 i to v progressively show the method by which Example A, 10, as indicated in FIG. 1, is mounted and deployed on the vehicle.

FIG. 3 shows another embodiment of the subject invention, Example C, 26.

FIG. 4 indicates the method by which Example C, 26, is mounted and deployed on the vehicle.

### DETAILED DESCRIPTION OF THE DRAWINGS

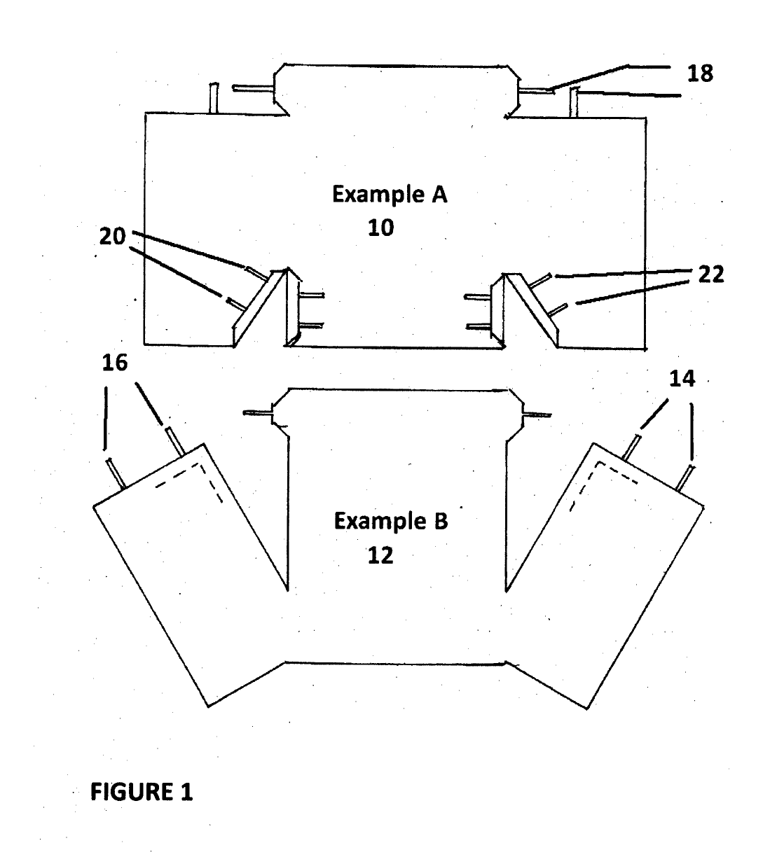

Referring now to FIG. 1 there is shown Examples A, 10, and B, 12, which are embodiments of the subject invention intended to be deployed by unrolling or unfurling under gravity from externally mounted storage and deployment means on the vehicle (not shown). It will be noted the plurality of panels will be made from a reflective heat dissipating and/or thermal insulating material or textile, each panel configured to cover an adjacent portion of the cabin of the vehicle (not shown). The straps or tags 14, 16, 18, 20, 22 provide for retention means to secure the panels by gripping between the shut doors and door frames of the cabin of the vehicle (not shown).

It should be appreciated that the term “vehicle” used throughout the specification has the general meaning portrayed to the person skilled in the art. However, such is intended to also include, but not limited to, people movers or personal use motor vehicles, emergency personal vehicles, caravans, trailers, or any other vehicle or body that may be occupied by personnel when they become trapped in a fire situation.

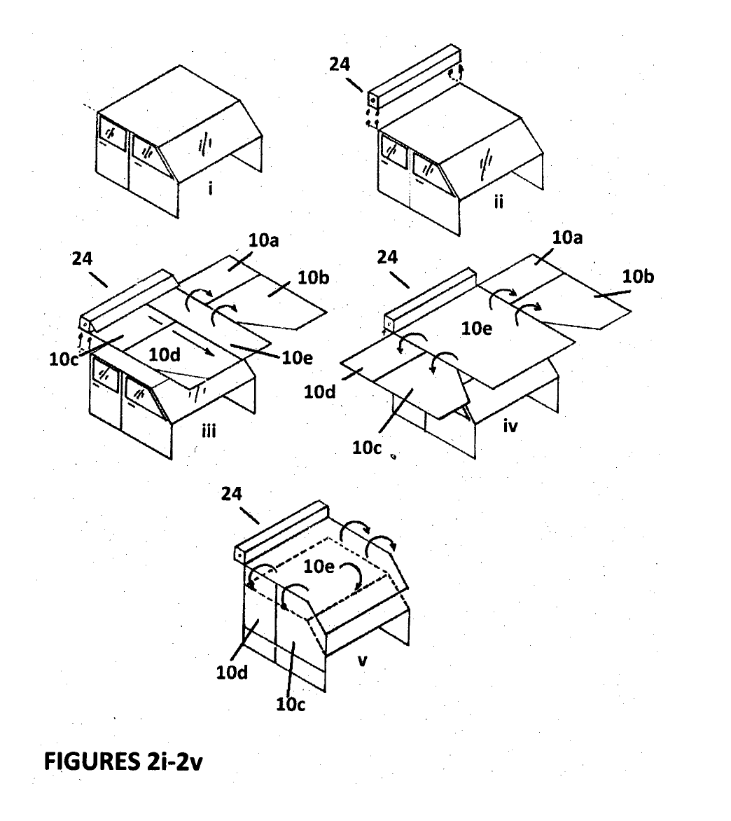

Referring now to FIG. 2(i) the general shape of a crew or single cabin area of a fire fighting vehicle is shown, with which the invention may be used. In FIG. 2(ii), the cover, A, 10, as depicted in FIG. 1, is shown to be mounted onto the roof of the vehicle within an enclosed, hinge-lidded, elongated container 24. The container 24 is one example of a storage and deployment means designed to effect rapid deployment of the cover.

In FIGS. 2(iii) and 2(iv), Example A 10 is shown to have unrolled and unfurled from storage and deployment container 24. Panels 10a, 10b, 10c and 10d are shown to have unfolded from their position above base panel 10e. In the interests of clarity, the straps or tabs which provide for retention means are not shown.

It will be noted from FIG. 2(v), that when Example A 10 is deployed, panel 10a will overlap with panel 10b, panel 10c will overlap with panel 10d, panel 10c will overlap with panel 10e and panel 10b will overlap with panel 10e. The fire protective cover will take a substantially rectangular shape encompassing or enclosing the cabin or body section of a vehicle, thereby protecting the cabin or body and its occupants from exposure to radiant heat, burning embers and flames. It will be obvious that the shape and dimensions of the panels will correspond to the type and make of the vehicle for which the cover is intended.

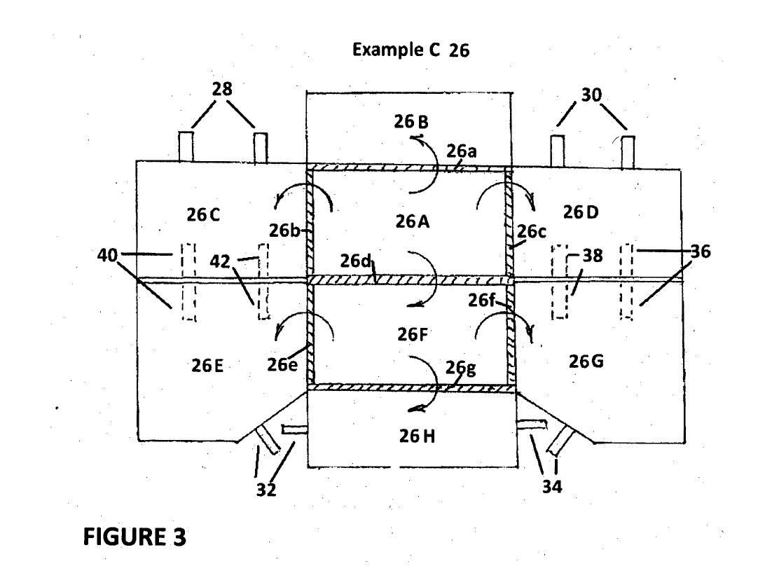

Referring now to FIG. 3 there is shown another preferred embodiment of the subject invention, Example C which is intended to be deployed by unfolding out from a compact arrangement (not shown). It will be noted the plurality of reflective panels intended to be made from a heat dissipating and/or thermal insulating material or textile, each panel configured to cover an adjacent portion of the cabin of the vehicle (not shown).

26a-g indicate the location of torsion springs, which is one example of a mechanical aid used to effect deployment of an unfolding cover. These torsion springs may be selectively varying strengths to assist in rapidly unfolding panels 26B, 26C, 26D, 26E, 26F, 26G and 26H in a successive, predetermined order from base panel 26A to cover the vehicle (not shown). When stored, the panels are folded against the bias of the springs and retained in place in a storage and deployment container strategically located on the vehicle (not shown). Automatic deployment of the cover is preferably triggered by a mechanism accessible within the vehicle such as a manual switch or an automatic trigger based on a thermostat or fusible link responsive to ambient temperature (not shown) operating a retaining pin or solenoid device (not shown).

While in the above explained embodiment reference is made to torsion springs as a preferred deployment mechanism, it shall be appreciated that other known mechanical deployment mechanisms can be used without departing from the spirit of the present invention. In particular, it is envisaged that a pneumatically powered system could be used to impart rapid deployment of an unfolding cover of the present invention. Additionally, a compressed air deployment system, mechanical gearing, electric motors and hydraulic energy are other examples of systems that could be adapted to impart rapid deployment of the cover of the present invention.

In use and after deployment of the cover, straps or tags 28, 30, 32, 34, 36, 38, 40, 42 may be used to further secure the panels by gripping between shut doors and door frames of the cabin of the vehicle (not shown).

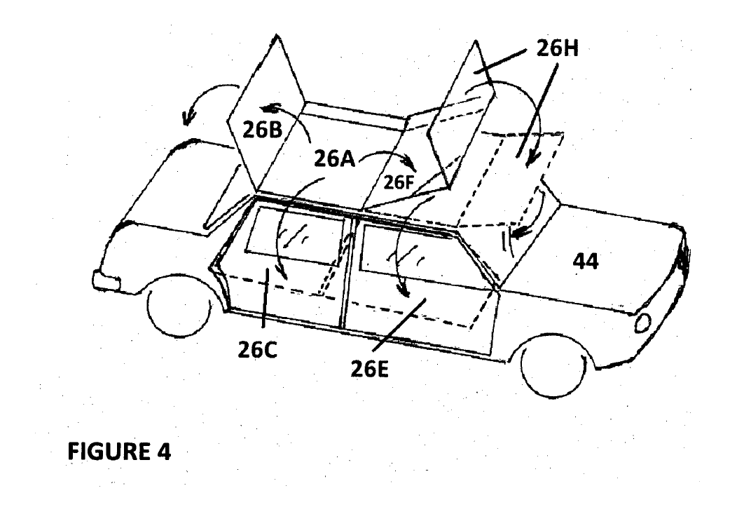

Referring now to FIG. 4 there is shown one example of a shape of a vehicle 44. The cover, C, 26, is shown to be mounted (method not shown) onto the roof of the vehicle 44. Obviously the shape and dimensions of the panels will correspond to the type and make of the vehicle for which the cover is intended to be used with. Panels 26B, 26C, 26E, 26F and 26H are shown to be unfolding from base panel 26A. Panels 26D and 26G also unfold from base panel 26A, but are not shown. In the interests of clarity, the straps or tabs which provide for the retention means are not shown. Panel 26B will overlap with panel 26D (not shown), panel 26D (not shown) will overlap with panel 26G (not shown), panel 26G (not shown) will overlap with panel 26H, panel 26H will overlap with panel 26 E, panel 26D will overlap with panel 26C and panel 26 C will overlap with panel 26B. The fire protective cover of the present invention, in preferred embodiments, will take a substantially rectangular shape encompassing or enclosing the cabin section or body of the vehicle 44, thereby protecting the cabin or body and any of its occupants from exposure to radiant heat, burning embers and flames. It will be obvious that the shape and dimensions of the panels will correspond substantially to the type and make of the vehicle for which the cover is intended to be used with

In all the above examples, the deployment is preferably triggered by a mechanism accessible within the vehicle, such as a manual switch or an automatic trigger based on a thermostat or fusible link responsive to ambient temperature (not shown) operating a retaining pin or solenoid device. During housing in the stored position for extended periods of time, the torsion springs may lose some tension, however it is envisaged that replacement springs may be installed when too much spring tension is lost. Moreover, other deployment mechanisms can be replaced if necessary during the life of the product.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

In the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

1-13. (canceled)

14. A fire protection external vehicle cover for protecting occupants of the vehicle from exposure to radiant heat, burning embers, and flames if the vehicle is moving through or becomes trapped in a fire, the cover comprising:
a plurality of reflective panels of a heat dissipating and/or thermal insulating material or textile; each panel configured to cover an adjacent portion of the cabin of the vehicle;
one or more panels including retention means to secure the panels by gripping between closed doors and door frames of the cabin;
storage and deployment means for storing and deploying the cover from one or more locations on the vehicle;
wherein when deployed the panels overlap one another so that gaps do not exist between adjacent panels such that the cover forms an enclosure over the cabin to protect external surfaces, windows, and a windscreen of the cabin.

15. The cover of claim 14, wherein the material or textile is a reflective single or multi-layered thermal insulating and/or heat dissipating fabric.

16. The cover according to claim 15, wherein the reflective material or textile is constructed of a flexible and fiber reinforced material selected from the group consisting of kevlar fibers, glass fibers, carbon fibers, aramid fibers, and combinations thereof.

17. The cover according to claim 14, wherein at least one of the panels covering the windscreen of the vehicle when deployed includes at least a portion that is transparent to permit vision outside of the vehicle.

18. The cover according to claim 14, wherein the storage and deployment means comprises one or more containers mounted on a roof of the vehicle which stores the cover in a rolled up or folded up configuration.

19. The cover according to claim 14, wherein deployment of the cover is rapidly effected under gravitational means when the cover is released from the storage and deployment enclosures.

20. The cover according to claim 14, wherein the retaining means for the panels of the cover comprises straps or tags that can be secured between the door frames and the closed doors of the vehicle body.

21. The cover according to claim 20, wherein when deployed, the panels can be further tensioned through tightening of the straps or tags, or use of tension drawstrings accessible from within the cabin.

22. The cover according to claim 14, wherein the storage and deployment means includes a mechanical aid to effect rapid deployment of the cover.

23. The cover according to claim 22, wherein the mechanical aid to effect deployment includes torsion springs or a pneumatic system.

24. The cover according to claim 22, wherein activation of the mechanical aid to impart deployment is triggered by a switching means accessible from within the vehicle.

25. The cover according to claim 24, wherein the switching means includes a thermostat or fusible link responsive to ambient temperature operating a retaining pin or solenoid device.
